(19) United States
(12) Patent Application Publication
(10) Pub. No.: US 2007/0193886 A1
(43) Pub. Date: Aug. 23, 2007

(54) DETECTION METHODS AND DEVICES

(76) Inventors: Ian Acworth, Melrose, MA (US); Paul Gamache, Hudson, NH (US); Michael Granger, Northborough, MA (US)

Correspondence Address: LOWRIE, LANDO & ANASTASI, RIVERFRONT OFFICE, ONE MAIN STREET, ELEVENTH FLOOR, CAMBRIDGE, MA, 02142, US

(21) Appl. No.: 11/670,555

(22) Filed: Feb. 2, 2007

Related U.S. Application Data
(60) Provisional application No. 60/764,411, filed on Feb. 2, 2006.

(51) Int. Cl. G01N 27/26

(52) U.S. Cl. 205/775; 204/400

(57) ABSTRACT

A device comprising an electrode constructed and arranged to electrochemically activate an electrochemically inactive analyte is disclosed. Methods and systems that implement the device are also provided.

### PRIORITY CLAIM

This application claims priority to U.S. Provisional Patent Application No. 60/764,411 filed on Feb. 2, 2006, the entire disclosure of which is hereby incorporated herein by reference for all purposes.

### GOVERNMENT RIGHTS

Certain technology disclosed herein may have been developed, at least in part, under grant no. IR21DK070326-01 awarded by the National Institutes of Health. The United States government may have certain rights in the technology.

### FIELD OF THE TECHNOLOGY

Certain examples disclosed herein relate generally to methods and systems for detecting species, such as metabolites. More particularly, certain examples disclosed herein relate to rendering or converting an electrochemically inactive molecule to an electrochemically active molecule for detection.

### BACKGROUND

Many analytical methods and systems are designed to analyze specific analytes. Analytes not having the physical or chemical properties that a particular detector is designed to detect remain undetected.

### SUMMARY

Certain features, aspects and examples disclosed herein are directed to devices that may be used to detect analytical species.

In accordance with a first aspect, a device comprising an electrode constructed and arranged to generate a reactive species to electrochemically activate an electrochemically inactive analyte is provided. In some examples, the electrode may be a boron doped diamond electrode. In certain examples, the reactive species may be, for example, hydroxyl free radicals, chlorine radicals, bromine radicals, nitrogen dioxide radicals, etc.

In accordance with an additional aspect, a system for detecting an electrochemically inactive analyte is provided. In certain examples, the system comprises an injector, an electrochemical cell fluidically coupled to the injector, the electrochemical cell comprising an electrode constructed and arranged to generate a reactive species to activate an electrochemically inactive analyte, and a detector configured to receive and detect activated analyte from the electrochemical cell.

In accordance with another aspect, a method of detecting an electrochemically inactive analyte using an electrochemical cell is disclosed. In certain examples, the method comprises generating a reactive species using an electrode to activate an electrochemically inactive analyte, and detecting the activated analyte.

In accordance with an additional aspect, an electrode constructed and arranged to generate a reactive species to activate an electrochemically inactive analyte for detection in an electrochemical detector is provided.

In accordance with another aspect, static (bulk) and flowing systems (e.g., LC/HPLC) may be used with the devices and methods disclosed herein. The exact configuration may vary. For example, a boron doped diamond electrode may be placed in-line either before an analytical column (to speciate products), post column or elsewhere in a system.

In accordance with an additional aspect, reactive species may be generated from a mobile phase (e.g., hydroxyl free radical formation from water), from additives to a mobile phase (e.g., chlorine radicals from the addition of HCl), from infusion of reactants prior to, for example, a boron doped diamond electrode, or using other mechanisms which will be selected by the person of ordinary skill in the art, given the benefit of this disclosure.

These and other features, aspects, examples and are described in more detail below.

### BRIEF DESCRIPTION OF THE FIGURES

Certain examples are described below with reference to the accompanying figures in which:

FIG. 1A is a schematic of a first embodiment of a benchmark apparatus, and FIG. 1B is a schematic of another embodiment of a benchmark apparatus, in accordance with certain examples;

FIGS. 2A and 2B are illustrative MS total ion (FIG. 2A) and EC-Array (FIG. 2B) chromatograms, in accordance with certain examples;

FIG. 3A shows chromatograms obtained using two cells, and FIG. 3B shows an oxidative metabolism scheme, in accordance with certain examples;

FIG. 4 is a schematic of a boron doped diamond electrode, in accordance with certain examples;

FIG. 5 is a schematic of a contact pin assembly, in accordance with certain examples;

FIG. 6 is a graph showing the response with respect to concentration for eleven aminothiols, disulfides and thioethers, in accordance with certain examples;

FIG. 7 is a liquid chromatogram showing separation of the eleven aminothiol, disulfide and thioether standards, in accordance with certain examples;

FIG. 8 is a liquid chromatogram showing separation of eleven compounds including aminothiols, disulfides and thioethers in a human plasma control sample, in accordance with certain examples;

FIG. 9 is a liquid chromatogram showing separation of eleven compounds including aminothiols, disulfides and thioethers in a uremic human plasma sample, in accordance with certain examples;

FIG. 10 is an overlay of several chromatograms including a chromatogram of standard aminothiols, disulfides and thioethers, chromatograms of non-uremic samples, and chromatograms from uremic samples, in accordance with certain examples; and

FIG. 11 is a hydrodynamic voltammetric graph for eleven aminothiol standards using a boron diamond doped electrode, in accordance with certain examples.

Certain features or elements in the figures are not necessarily to scale. Certain elements may have been enlarged, distorted or otherwise shown in an unconventional manner relative to other features to provide a more user-friendly description of the illustrative features, aspects and examples described herein.

### DETAILED DESCRIPTION

In accordance with certain examples, the methods and devices disclosed herein may be used to facilitate a range of studies such as, for example, metabolomics studies, by combining electrochemical (EC) and mass spectrometric (MS) technologies to extend the capabilities of LC-based analyses. For example, integration of existing EC and MS technologies in serial and parallel configurations may be performed. In addition, EC sensors and reactors, software and detection modalities to substantially extend the scope, throughput, quantitative and qualitative capabilities of both EC and MS may also be implemented.

In accordance with certain examples, the devices and systems disclosed herein may be hyphenated to one or more additional devices. These additional devices include, but are not limited to, liquid chromatographs such as those commercially available from Waters Corp. (Milford, Mass.), Thermo Fisher Scientific, Inc. (Waltham, Mass.), Shimadzu (Japan), mass spectrometry devices, such as those commercially available from PerkinElmer, Inc. (Waltham, Mass.), Thermo Fisher Scientific, Inc., Agilent Technologies, Inc. (Santa Clara, Calif.), Waters Corp. (Milford, Mass.), Bruker (Billerica, Mass.), Shimadzu (Japan), and the like, or may be hyphenated to other analytical devices, such as ultraviolet/visible light detectors, fluorescence detectors, an evaporative light scattering detectors (ELSDs), chemiluminescence detectors (CLNDs), infrared detectors and nuclear magnetic resonance devices commercially available from Bruker, Varian, Inc. (Palo Alto, Calif.) and Agilent Technologies, Inc. and other manufacturers. The devices disclosed herein are particularly useful to activate or detect (or both), species in a fluid flow stream that elutes from a separation column.

In accordance with certain examples, the devices disclosed herein may be constructed and arranged to activate and/or detect an electrochemically inactive analyte. Activation of an inactive analyte includes providing a reactive species that can attach to or tag the analyte to render it electrochemically detectable. In certain examples, the device may also be used to detect the activated analyte after it has activated the electrochemically inactive analyte. In examples where an analyte is electrochemically active prior to analysis with the device, the device may be used in a detector capacity, e.g., a BDD electrode may be used to detect the analyte, and is not needed to activate the analyte.

In accordance with certain examples, the devices disclosed herein may be used to activate, detect, or activate and detect many different types of samples. In particular, any chemical compound that may be rendered electrochemically active may be used with the devices, systems and methods disclosed herein. In one embodiment, the sample may be a biological sample. Biological samples include samples that have one or more of the following species present in the sample: an amino acid, a protein, a carbohydrate, a lipid, a triglyceride, a phospholipid, a sphingolipid, a wax, a terpene, a steroid, a nitrogenous base, a nucleic acid, a nucleoside, a nucleotide, a polynucleotide and the like. Biological samples also include samples commonly obtained in a clinical setting including, but not limited to, a urine sample, a blood sample, a saliva sample, a hair sample, a skin sample, a DNA sample, air sampled from expiration, a spinal fluid sample, a tissue sample, an ocular fluid sample, a mucus sample, a stool sample, a vaginal sample and the like. It may be desirable to subject the sample to one or more processing steps, e.g., purification, extraction, centrifugation, chemical modification, etc., prior to activation and/or detection using the devices, systems and methods disclosed herein.

In accordance with certain examples, where a sample, such as a biological sample, is subjected to separation prior to analysis, different types of solutions, salts, mobile phases and the like may be used to separate the species depending on the nature and properties of the species in the sample. Illustrative materials suitable for use in separating the species in a sample include, but are not limited to, buffers, ion-pair agents, viscosity modifiers, salts, surfactants, organic solvents, etc. It will be within the ability of the person of ordinary skill in the art, given the benefit of this disclosure, to select suitable materials and conditions for separating the species in a sample.

In accordance with certain examples, the devices disclosed herein may be used for inline detection of chemical species. For example, waste products from a chemical process may be passed to the device and may be detected, rendered electrochemically active for detection or both. The devices disclosed herein may be integrated into existing detection devices such that the device is fluidically coupled to the waste product stream, or a device may be fluidically coupled to an inline fluid stream by splitting the fluid flow into 2 or more channels and coupling one channel to the device for activating or detecting, or both, of species in the fluid stream.

In accordance with certain examples, the devices disclosed herein may be used in many existing electrochemical devices. For example, a device that includes a BDD electrode may be used in a CoulArray® or Coulochem® detector commercially available from ESA Biosciences, Inc. (Chelmsford, Mass.). The device may also be used in other commercially available electrochemical devices, such as those available from, for example, Bioanalytical Systems (Indianapolis, Ind.), Antec Leyden (Netherlands), Dionex (Calif.) and Eicom (Japan) In addition, the exact form of the device may vary depending on the configuration of the detector. In some examples, the electrode of the device may be embedded into an electrode connector holder, which may be placed in the instrument. In some examples, the BDD electrode may replace an existing electrode in a detector. In other examples, one or more accessory devices, such as the contact pin assembly described below, may be used with the electrode. Additional configurations of a device that includes an electrode to electrochemically activate an analyte, or to detect an electrochemically active analyte or both, will be readily detected by the person of ordinary skill in the art, given the benefit of this disclosure.

In accordance with certain examples, devices disclosed herein that include a boron doped diamond electrode may be used to detect electrochemically active species, or species that are partially electrochemically active, e.g., compounds having a high oxidation potential, that are hard to detect with existing electrodes. Such species may be hard to detect due to, for example, a low response due to a high oxidation potential or electrode fouling. Illustrative hard to detect species include, but are not limited to, disulfides, certain DNA bases, e.g., purines such as adenine or adenosine, most pyrimidines, intermediary metabolites (e.g., S-adenosyl methionine [SAM] and S-adenosyl homocysteine [SAH]), tryptophan metabolites (e.g., kynurenic acid), aliphatic primary, secondary and tertiary amines, lipid hydroperoxides, certain amino acids and amines such as histidine and histamine, prostaglandins, leukotrienes; cyclic AMP, protein damage markers (e.g., 3-nitrotyrosine) and the like.

In accordance with certain examples, the electrode of the devices and systems disclosed herein may be subjected to one or more conditioning steps prior to use. For example, the electrode may be cycled in a suitable solution to condition the electrode for use. Cycling of the electrode may result in activation of the electrode by enriching the electrode surface with covalently attached oxygen moieties. In some examples, cycling the electrode may provide the ability to regenerate a hydrogen terminated surface electrochemically to affect changes in EC activity. Illustrative solutions for conditioning an electrode include, but are not limited to, acids such as sulfuric acid, nitric acid, etc. (which may be diluted to provide a suitable concentration, e.g., 0.1-0.5 M), bases such as sodium hydroxide, carbonate, acetate and the like or other selected solutions. In examples where an electrode is conditioned by cycling, the cycling may be slow anodic cycling or other known methods of cycling typically performed in electrochemical analysis. It will be within the ability of the person of ordinary skill in the art, given the benefit of this disclosure, to perform suitable steps to condition an electrode prior to use in the devices, systems and methods disclosed herein.

In accordance with certain examples, the metabolome is incredibly complex, consisting of thousands of compounds-the product of an organism's biochemistry (i.e., the classic enzyme-based biochemical pathways delineated in general biochemical textbooks or metabolic pathway charts) with, in the case of higher organisms, contribution from gut microorganism metabolism. An extra degree of complexity comes from numerous novel metabolites, often produced in an enzyme-independent manner, that result from disease or metabolism of xenobiotics. For example, during inflammation, the over production of a variety of oxidizing species (including the hydroxyl free radical, peroxynitrite and hypochlorous acid) by the immune system can produce unique metabolites, such as DNA adducts (e.g., 8-hydroxy-2′deoxyguanosine [8-OH2′dG]), oxidized proteins (e.g., 3-nitrotyosine) and lipid peroxidation products (e.g., F2alpha-isoprostanes). Some of these are currently used as potential biomarkers (e.g., urinary 8-OH2′dG; urinary 8-epi-isoprostane F2alpha) for diseases, although their potential clinical relevance is still being evaluated. The activity, side effects and toxicity of some drugs may result from production of oxidizing species or reactive intermediates, and depletion of protective antioxidants, and sometimes results in the formation of unique metabolites (e.g., high doses of acetaminophen are metabolized primarily by CYP2E1 forming a reactive quinoneimine). This rapidly depletes protective glutathione levels with the formation of unique acetaminophen-glutathione conjugates. Developing an analytical platform capable of measuring such diverse chemical species, at biologically relevant levels, is challenging. However, the combination of MS, EC and CAD in embodiments of the devices and methods disclosed herein, addresses some of the challenges noted above.

In accordance with certain examples, a boron doped diamond (BDD) cell may be used in the methods and devices disclosed herein. Use of a BDD cell can provide certain advantages such as, for example, less baseline drift during gradient runs, better long-term response stability for high potential applications, the generation of extremely reactive compounds that can render a redox inactive compound redox active or be consumed by a redox inactive compound so that its concentration is lessened to act as a secondary detection scheme. BDD electrodes may be used in existing cells or may be used in cells or devices that can interface or couple to existing LC systems, e.g., HPLC systems.

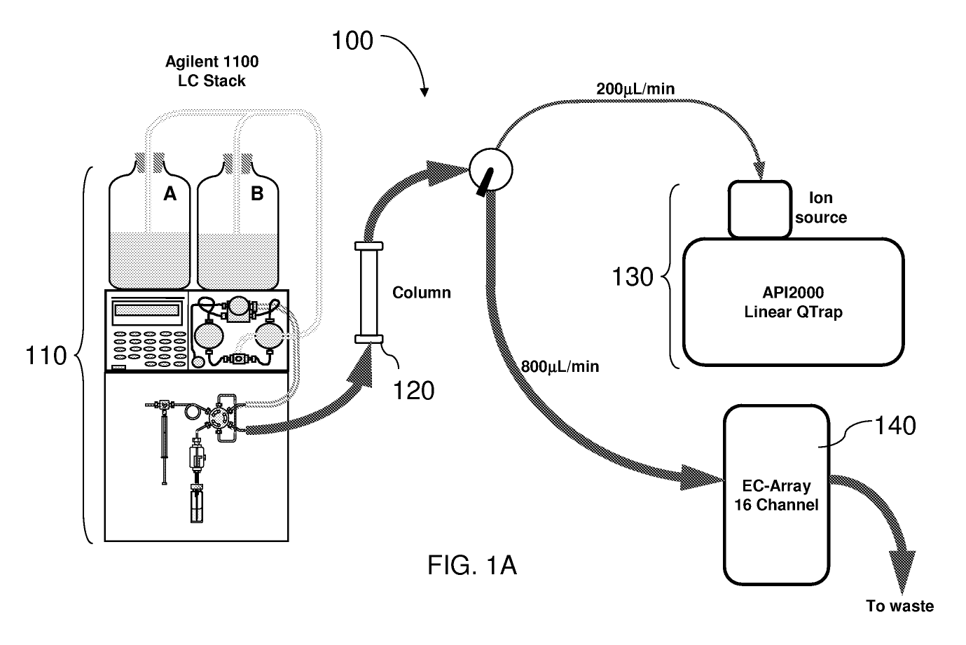

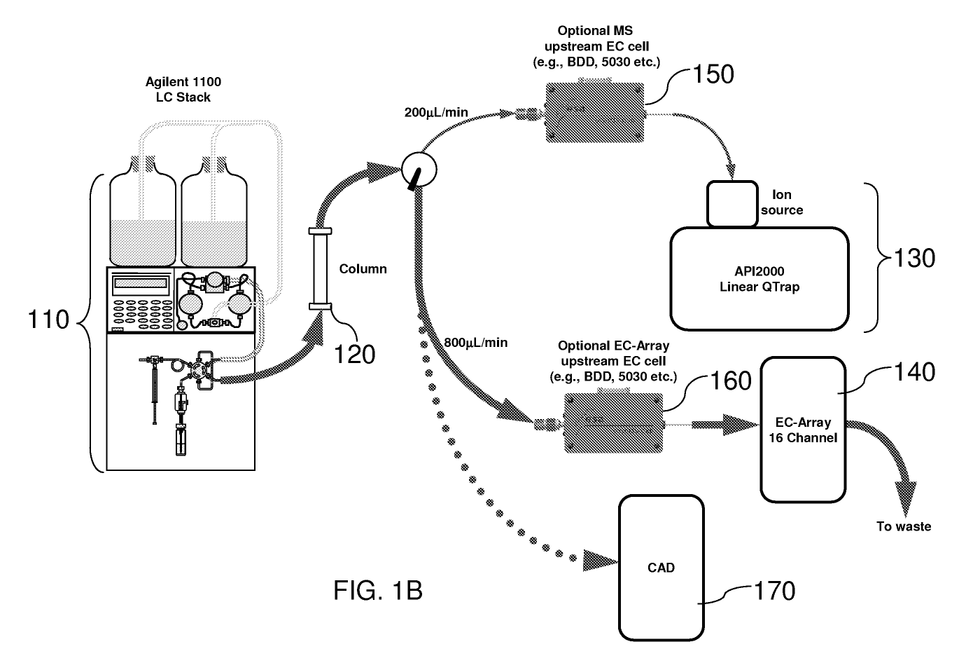

In a first example, a basic device may be assembled using commercially available (unless otherwise noted) EC and MS technologies. Referring to FIG. 1A, the device 100 includes an Agilent 1100 LC system 110 with a binary pump, autosampler and thermal chamber. Post-column flow may be passively split after column 120 to two detection arms: one for MS 130 and one for EC-Array 140. The flow rate may be varied to each arms, e.g., 200 μL/min flows to the MS and 800 μL/min flows to the EC-Array arm. The MS instrument 130 may be any suitable MS instrument such as, for example, a quadrupole—linear ion trap hybrid (ABI 2000 Q-Trap). Other suitable MS instruments will be readily selected by the person of ordinary skill in the art, given the benefit of this disclosure. The EC-Array 140 may be any suitable EC-Array, such as the EC-arrays commercially available from ESA Biosciences, Inc. (Chelmsford, Mass.). For example, the EC-Array may include 16 EC flow cells (ESA Model 6210) arranged in series each controlled at a fixed potential (DC mode) using ESA's CoulArray® detector module. This device may also be configured to accommodate experiments that include EC in series with MS (discussed below). Suitable software, such as ABI's Analyst™ software, may be used for instrument control and data acquisition from the LC and MS modules, while ESA's CoulArray® software may be used for control and acquisition from the parallel EC-Array module. Data acquisition from MS and EC-Array may be synchronized with sample injection by using a simple contact closure from the autosampler, which allows for automated runs.

In accordance with certain examples, the use of volatile buffers, typically 20 to 50 mM, can provide a sufficient level of supporting electrolyte without adversely affecting MS performance. Also, in one configuration, a stainless steel fluidic union may be connected to the ground of the MS high voltage power supply. In addition, the use of an adjustable passive flow splitter (ESA part # 70-6337) with 1:1 to 1:20 split ratio capabilities can provide a reliable means of performing various experiments. In general, the flow ratio may be adjusted to optimize MS performance provided that the flow to the EC-Array is at least 0.5 mL/min, in consideration of EC flow cell volume.

In accordance with certain examples, to test the devices and methods disclosed herein several experiments were performed to establish a baseline for comparison to the use of an electrochemical cell designed to enhance or allow a signal from an otherwise electrochemically inactive compound. Some experiments used standards and were designed to ensure that a combined EC-MS system performs as expected. Other experiments were directed to exploratory analysis of biological matrices and were geared toward establishing a performance benchmark for comparison. In certain examples, separation and EC and/or MS detection of at least one representative metabolite from each of the following biological compounds may be performed: amino acid, antioxidant, flavonoid, monoamine, thiol and vitamin with limits of detection (LOD) of less than 500 pg on-column, and precision (% RSD) for 10 replicate injections of less than 5 for 1 μg levels and at least 3 orders of magnitude dynamic range. The detection scope, limits of detection (LOD), precision and dynamic range were studied using standard compounds representing each of the above classes (23 standard compounds used for this study). The results that establish the baseline are shown in Table 1 below.

TABLE 1

| | | | | | Response variability | | Linear Dynamic | |
|---|---|---|---|---|---|---|---|---|
| | | Retention time (min) | | | RSD (%) | | Range r² | |
| | MW | CAD | MS | EC-Array | MS | EC-Array | MS | EC-Array |
| Amino Acids | | | | | | | | |
| Alanine (Ala) | 93.1 | 0.86 | ND | ND | ND | ND | ND | ND |
| Leucine (Leu) | 131.2 | 2.45 | 2.6 | ND | 5.02 | ND | 0.948 | ND |
| Tryptophan (Trp) | 204.2 | 5.96 | 6.11 | 6.1 | 6.17 | 0.51 | ND 10 ng | 0.999 |
| Tyrosine (Tyr) | 181.2 | 3.1 | 3.24 | 3.17 | 2.77 | 4.16 | ND 10 ng | 0.999 |
| Antioxidants | | | | | | | | |
| Ascorbic Acid (AA) | 176.1 | 1.38 | 1.53 | 1.4 | 19.92 | 1.3 | ND 10 ng | 0.995 |
| Uric Acid (UA) | 168.1 | 2.55 | 2.7 | 2.57 | 3.36 | 2.17 | ND 10 ng | ND 10 ng |
| Glutathione (GSH) | 307.3 | 1.69 | 1.84 | 1.8 | 4.2 | 3.05 | 0.999 | 0.995 |
| Monoamines | | | | | | | | |
| Acetylcholine (ACH) | 145.2 | 1.32 | 1.48 | ND | 10.62 | ND | 0.946 | ND |
| Dopamine (DA) | 153.2 | 2.37 | 2.52 | 2.36 | 7 | 0.91 | 0.993 | 0.99 |
| Epinephrine (E) | 183.2 | 1.41 | 1.57 | 1.43 | 8.19 | 0.8 | 0.999 | 0.999 |
| 5-Hydroxyindole acetic acid (5HIAA) | 191.2 | 6.92 | 7.08 | 6.96 | 4.34 | 1.71 | ND 10 ng | 0.999 |
| Homovanilic Acid (HVA) | 182.2 | 7.41 | ND | 7.5 | ND | 0.77 | ND | 0.999 |
| Dihydroxyphenyl acetic acid (DOPAC) | 168.1 | 5.96 | ND | 5.97 | ND | 0.29 | ND | 0.984 |
| Histamine (HSN) | 111.1 | 0.87 | 0.93 | ND | 12.95 | ND | 0.95 | ND |
| Flavonoids | | | | | | | | |
| Catechin (CAT) | 290.3 | 6.9 | 7.06 | 6.95 | 7.62 | 0.71 | ND 10 ng | 0.999 |
| ^{a}Hesperidin (HES) | 610.6 | 9.37/10.08 | 9.52/10.23 | 9.48/10.21 | 3.58 | 0.63 | 0.999 | 0.999 |
| Quercetin (QUE) | 338.3 | 7.95 | ND | 8.03 | ND | 0.63 | ND | 0.999 |
| Thiols | | | | | | | | |
| Cysteine (Cys) | 121.2 | 0.91 | 1.07 | 1.02 | 5.32 | 0.96 | ND 10 ng | 0.99 |
| Homocysteine (HCys) | 135.2 | 0.84 | ND | 1.12 | 2.81 | 0.69 | ND 10 ng | ND 10 ng |
| S-Adenosyl-Methionine (SAM) | 399.4 | 6.38 | 6.45 | 6.4 | 5.17 | 0.67 | ND 10 ng | 0.993 |
| S-Adenosyl-Homocysteine (SAH) | 384.4 | 4.25 | 4.4 | 4.39 | 1.15 | 0.63 | 0.994 | 0.985 |
| Vitamins | | | | | | | | |
| Riboflavin (RF) | 376.4 | 7.39 | 7.54 | ND | 5.39 | ND | 0.995 | ND |
| 5-Methyltetrahydrofolic Acid (MTHF) | 504.3 | 5.64 | ND | 5.74 | ND | 1.1 | ND | ND 10 ng |

In Table 1, standard compounds (23 compounds) were detected at 200 ng level using MS, CAD or EC-Array and are indicated by a retention time entry. Response variability was calculated as RSD for 10 injections of 1 μg; R² was calculated from least-squares regression of mass vs. peak area for 1 μg, 100 ng & 10 ng levels. In Table 1, the following abbreviations were used: ND=Not Detected; ND10 ng=10 ng level not detected. A more comprehensive set of standards (36 compounds, including the 23 compounds used for quantitation studies, Table 2) was used to facilitate peak identification of metabolites in plasma and urine. In Table 2, detection of compounds at 200 ng level is indicated by the presence of a retention time. Those species not detected are represented by ND. 4HPLA, 4HBA, and SAM were not present in the extended standard mixture; however, data from these individual compounds was collected.

TABLE 2

| | | Retention time (min) | | |
|---|---|---|---|---|
| | MW | CAD | MS | EC-Array |
| Amino Acids | | | | |
| Alanine (Ala) | 93.1 | 0.86 | ND | ND |
| Leucine (Leu) | 131.2 | 2.45 | 2.6 | ND |
| Tryptophan (Trp) | 204.2 | 5.96 | 6.11 | 6.1 |
| Tyrosine (Tyr) | 181.2 | 3.1 | 3.24 | 3.17 |
| Antioxidants | | | | |
| Ascorbic Acid (AA) | 176.1 | 1.38 | 1.53 | 1.4 |
| Uric Acid (UA) | 168.1 | 2.55 | 2.7 | 2.57 |
| Glutathione (GSH) | 307.3 | 1.69 | 1.84 | 1.8 |
| Monoamines | | | | |
| Acetylcholine (ACH) | 145.2 | 1.32 | 1.48 | ND |
| Dopamine (DA) | 153.2 | 2.37 | 2.52 | 2.36 |
| Epinephrine (E) | 183.2 | 1.41 | 1.57 | 1.43 |
| 5-Hydroxyindole acetic acid (5HIAA) | 191.2 | 6.92 | 7.08 | 6.96 |
| Homovanilic Acid (HVA) | 182.2 | 7.41 | ND | 7.5 |
| Dihydroxyphenyl acetic acid (DOPAC) | 168.1 | 5.96 | ND | 5.97 |
| Histamine (HSN) | 111.1 | 0.87 | 0.93 | ND |
| Vanillylmandelic Acid (VMA) | 198.2 | 4.01 | ND | 4.07 |
| 4-Hydroxyphenyl acetic acid (4HPAC) | 152.1 | 7.01 | ND | 7.07 |
| 4-Hydroxyphenyl lactic acid (4HPLA) | 182.2 | 6.03 | ND | 6.18 |
| 4-Hydroxy benzole acid (4HBA) | 138.1 | 6.8 | ND | 6.96 |
| Flavonoids | | | | |
| Catechin (CAT) | 290.3 | 6.9 | 7.06 | 6.95 |
| ^{a}Hesperidin (HES) | 610.6 | 9.37/10.08 | 9.52/10.23 | 9.48/10.21 |
| Quercetin (QUE) | 338.3 | 7.95 | ND | 8.03 |
| Thiols | | | | |
| Cysteine (Cys) | 121.2 | 0.91 | 1.07 | 1.02 |
| Homocysteine (HCys) | 135.2 | 0.84 | ND | 1.12 |
| S-Adenosyl-Methionine (SAM) | 399.4 | 6.38 | 6.45 | 6.4 |
| S-Adenosyl-Homocysteine (SAH) | 384.4 | 4.25 | 4.4 | 4.39 |
| Cysteinylglycine (CysGly) | 178.2 | 1.07 | 1.22 | 1.17 |
| Vitamins | | | | |
| Riboflavin (RF) | 376.4 | 7.39 | 7.54 | ND |
| 5-Methyltetrahydrofolic Acid (MTHF) | 504.3 | 5.64 | ND | 5.74 |
| Dietry Metabolites | | | | |
| Enterolactone (ENT) | 298.3 | 12.58 | 12.72 | 12.66 |
| Daidzein (DZE) | 254.2 | 10.93 | 11.08 | 11.08 |
| Equol (EQ) | 242.2 | 12.43 | 12.58 | 12.51 |
| Genistein (GEN) | 270.2 | 12.48 | 12.64 | 12.63 |
| Purine Metabolism | | | | |
| Xanthine (X) | 152.1 | 3.45 | 3.6 | 3.4 |
| Guanosine (GR) | 283.2 | 4.48 | 4.63 | 4.61 |
| Indole Metabolism | | | | |
| Kynurenine (KYN) | 208.2 | 4.57 | 4.73 | 4.64 |
| 3-Hydroxy Kynurenine (3OHKY) | 224.2 | 2.96 | 3.12 | 2.9 |
| Percent Detected | | 36/36 | 27/36 | 31/36 |
| | | 100% | 75% | 86% |

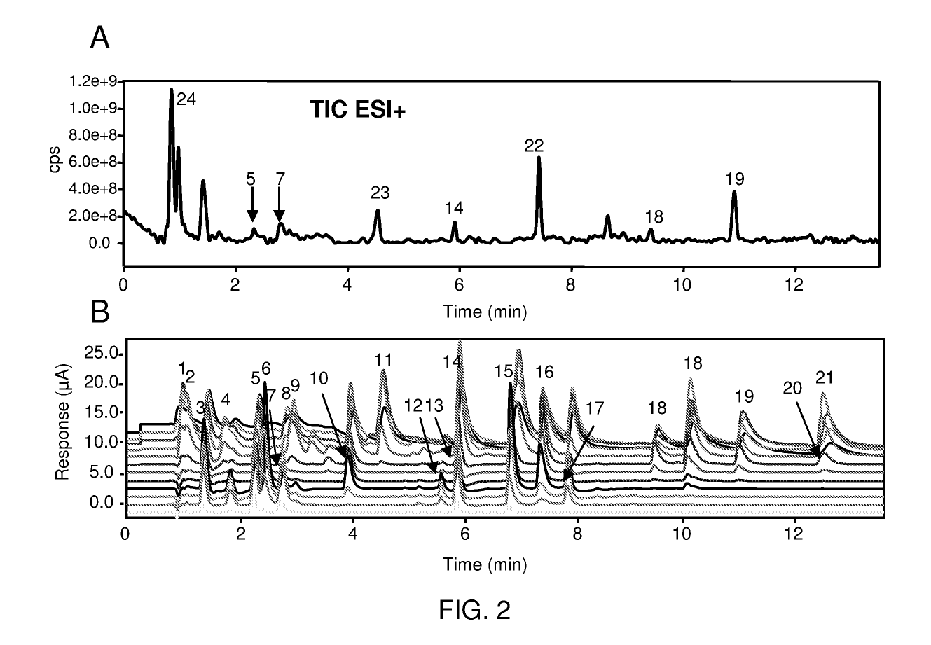

In accordance with certain examples, a representative MS and EC-Array chromatogram of the standard compound mixture is shown in FIGS. 2A and 2B. The EC-Array multi-channel chromatogram illustrates the response of several redox active metabolites and demonstrates resolution of co-eluting analytes based on differences in their relative ease of oxidation. As expected, the corresponding MS total ion chromatogram (TIC) shows relatively few, directly visible, metabolite peaks. Extracted ion data based on the pseudomolecular ion (i.e., protonated molecule, adduct) was used for each compound as the basis for MS data analyses. Representative MS total ion (FIG. 2A) and EC-Array (FIG. 2B) chromatograms from a single injection of the extended standard mixture (33 compounds at 200 ng each) are shown. An Agilent 1100 stack with AB 2000 Q-Trap and CoulArray (model 5600), as described above, were used to obtain these chromatograms. A 15 min. binary gradient from 1-64% aqueous acetonitrile was run with constant supporting electrolyte: 50 mM formic acid, 10 mM ammonium formate. ABI Qtrap2000 ESI positive ion EMS scan 75-750 m/z. EC-Array channels were at 70 mV increments from 100 mV to 1150 mV (16 channels). The column was a Shiseido MG 4.6×75 mm, 3 μm. Compound abbreviations are shown in Table 2. Peak identity is as follows: (1) Cys, (2) HCys, (3) AA, (4) GSH, (5) DA, (6) UA, (7) 30HKY, (8)Tyr, (9) X, (10) VMA, (11) GR, (12) MTHF, (13) DOPAC, (14) Trp, (15) 5HIAA/CAT, (16) HVA, (17) QUE, (18) HES (2 peaks), (19) DZE, (20) EQ, (21) GEN, (22) RF, (23) KYN, (24) HSN. It should be noted that eight peaks were identified in TIC trace (FIG. 2A); a further ten peaks were identified using XIC (FIG. 2B).

For 200 ng quantities, 17 of the 23 compounds studied were detected by MS and 18 by EC-Array, 13 by both techniques and one by neither (Table 1). As expected, compounds lacking typical carbon-based ‘EC-active’ moieties (e.g., phenol, secondary and tertiary amine, thiol, etc.) were not detected by EC-Array. A primary aspect of certain embodiments disclosed herein is to extend the scope of EC detection to other chemical classes by developing new EC cells that are configured to electrochemically activate species not detected by EC. The majority of compounds not detected by MS were weak acids (e.g., HVA, AA, DOPAC). This result might be expected given their propensity to exist as solution-phase neutral species using the described conditions (i.e., low pH eluent, positive mode electrospray ionization [ESI]). The development of new EC cells described herein is also geared toward extending the condition-dependent scope of MS detection by using EC to assist MS ionization.

In certain examples, lower limits of detection (LOD) were estimated based on the signal to noise ratio (S/N) obtained for 500 pg column quantities. Using the described conditions, two compounds were detected at this level by MS with a signal-to-noise ratio greater than 3. Based on the S/N obtained with higher amounts, the LOD for the majority of compounds detected by MS was estimated to be in the low (1 to 20) ng range. For EC-Array, one amino acid (TRP), two antioxidants (AA, QUE), one thiol (Cys), one vitamin (AA), three flavonoids (CAT, HES, QUE), and four monoamines (DA, 5HIAA, HVA, DOPAC) were detected at the 500pg level with a signal-to-noise ratio greater than 3. The higher apparent LOD achieved with MS may be attributed to the wide m/z scan range used. While linear ion trap scanning (i.e., enhanced MS) was used to maximize full scan sensitivity, it is widely recognized that much greater improvements in LOD may be achieved with targeted MS (e.g., selected ion monitoring, multiple reaction monitoring). Likewise, LOD with an EC-Array may be significantly improved when analysis is targeted to specific analytes as evidenced by numerous reports of low pg detection achieved with LC-EC-Array. Furthermore, pre-processing, e.g., smoothing, signal averaging, and background subtraction, may also be used to improve the LOD achievable with both EC and MS.

In accordance with certain examples, within-run response variability was measured as RSD for 10 replicate injections of 1 μg each (Table 1). Eighteen compounds at this level were detected by MS; the response (XIC peak area) variability ranged from 1.45% to 19.92%, mean=6.44% (7 compounds with a relative standard deviation less than 5%). For the 18 compounds detected by EC, response (dominant channel peak area) variability ranged from 0.29 to 4.16, mean=1.20 (all 18 with a relative standard deviation less than 5%). The higher variability observed with MS may be attributed to the wide scan range and to the use of only raw data. Signal normalization techniques (e.g., with internal standards) may be used to significantly improve MS precision.

In accordance with certain examples, dynamic range was estimated from R² calculated from least-squares regression analysis from replicate injections of 1000 ng (n=10), 100 ng (n=3) and 10 ng (n=3) of each compound. Of the 18 compounds detected by EC, the response at the 10 ng level for three compounds (UA, MTHF and HCys) was below the LOD. For the 15 remaining ‘EC active’ compounds, R² was greater than 0.985 (mean=0.994). Of the 18 compounds detected by MS, the response at the 10 ng level for nine compounds was below the LOD. For the nine remaining compounds, R² was greater than 0.946 (mean=0.98).

In accordance with certain examples, at least certain embodiments of the EC cell technology disclosed herein are directed to three broad categories of utilization: detection, reaction and MS modulation. This includes various working electrode (WE) materials that may allow detection of ‘additional’ metabolites with improved analytical figures of merit when compared to existing EC-Array cells. One goal of extending the analytical scope of EC-Array is integral with the use of alternative WE materials to effect reactions (e.g., metabolic mimicry or EC-assisted MS ionization) that are not observed with existing porous carbon cells. One configuration that was tested was a boron doped diamond (BDD) working electrode. A greater than 10-fold improvement in signal-to-noise over existing EC-Array cells is desirable. Illustrative compounds that may be detected with a BDD working electrode include, but are not limited, to biological molecules, such as, for example, polyamines, amino acids, carbohydrates, aliphatic amines, peptides, fatty acids, aminothiols, disulfides and thioethers, pyrimidines, histamine, and kynurenic acid.

In accordance with certain examples, EC cells employing BDD WE were evaluated to increase the useable working potential window and for resistance to surface fouling as compared to other carbon-based electrode materials. BDD offers several attractive features as an electrode material. From a materials standpoint, natural or synthetic diamond (which is an allotrope of carbon) is an excellent insulator with an energy band gap of 5.5 eV, which in itself is inauspicious for an electrode; however, when moderately doped with an electron acceptor (e.g., boron), the material behaves as a p-type semiconductor and when heavily doped takes on metallic-like electronic character. The small effective capacitance of the BDD material (important in determining nominal background current and noise characteristics), its as-grown monofunctionalized surface, and its aversion to corrosion, provides an electrode that is useful in the detection of various biological metabolites. The aforementioned attributes provide BDD with a useable potential window near 4 volts in aqueous media, a surface that is extremely resistant to fouling, a low background current, and a surface that can be easily cleaned in situ.

In accordance with certain examples, the BDD material used for certain experiments was grown as a thin layer using a hot filament chemical vapor deposition on a silicon substrate. The approximately 500 μm thick BDD film was removed from the silicon substrate leaving a free-standing film that was subsequently assembled in a ceramic holder used in ESA Bioscience's existing amperometric cells, e.g., an ESA amperometric cell model 5040 or model 5041. At potentials approaching the thermodynamic value for anodic water breakdown (+1.2 V vs. normal hydrogen electrode [NHE]) traditional metal or carbon electrodes discharge water to oxygen (2H₂O→4e−+4H++O₂) which can halt analyte oxidation or other analytically important reactions. Unlike these electrode materials, the anodic discharge of water at BDD occurs at higher potentials (greater than +2.2V) where the EC oxygen transfer reaction is mediated by reactive hydroxyl radicals (OH.) that are weakly adsorbed to the surface much like other electrodes that show low anode activity for oxygen evolution (Bi⁵⁺ or Fe³⁺ doped Ti/PbO₂ electrodes).

In accordance with certain examples, the extended potential window realized with a BDD electrode in aqueous media allows analytically important EC reactions that occur at higher potentials to be observed, reactions that until recently were thought to be electrochemically inaccessible (i.e., the direct electrochemical incineration of phenolic waste). Furthermore, the ability of OH. to be formed at high positive potentials provides the possibility to use reactions that are not possible with direct electrochemistry such as hydroxylation of aromatic structures (e.g., reactions that are catalyzed by enzymes).

In accordance with certain examples, characterization of the BDD electrodes disclosed herein involved obtaining cyclic voltammograms (CVs) in 0.1 M perchloric acid and comparing kinetic data for two well-known analytes (dopamine and ferri/ferrocyanide) to literature values. As expected, the background CVs showed a featureless capacitive envelope between the onset of oxygen and hydrogen evolution at +2.2 V and −1.0 V respectively. Dopamine and the ferri/ferrocyanide redox couple were used as benchmark compounds to compare thermodynamic and kinetic values obtained at BDD electrodes to those of published values.

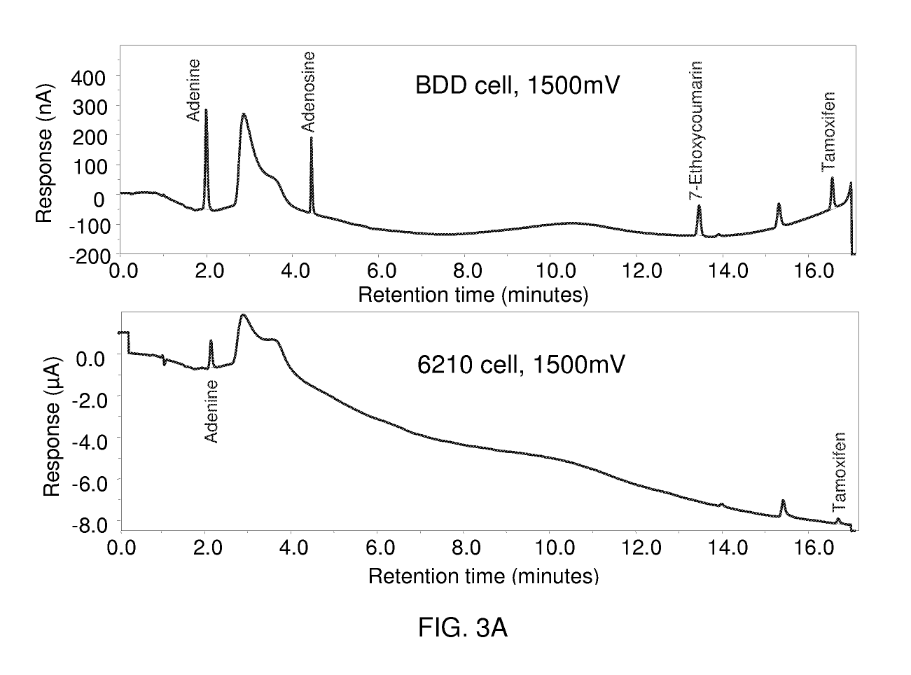

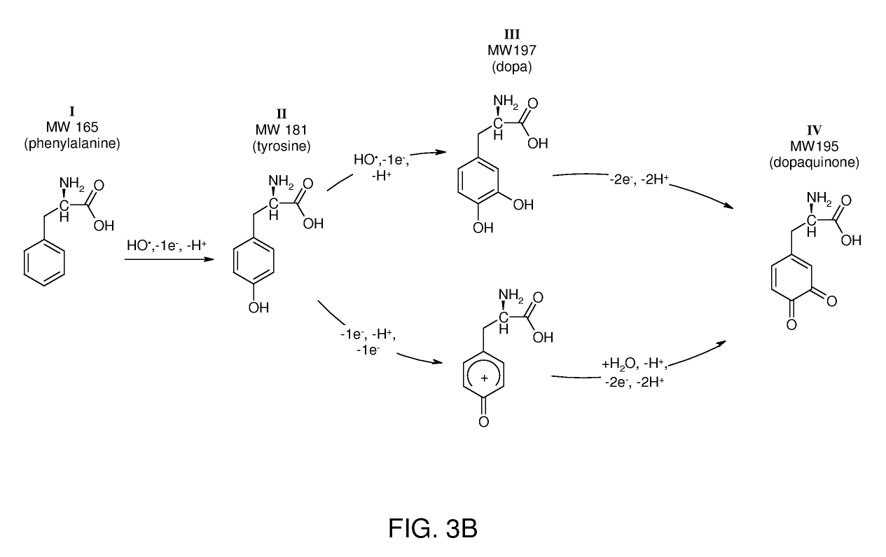

In accordance with certain examples, initial scoping studies were conducted using the chromatographic conditions described above. Thirty-two model compounds were chosen to represent a diversity of chemical classes and to provide insight to EC reaction mechanisms. Many of these compounds, however, were not retained using reverse phase LC conditions, even with weak eluents. Therefore, compounds that were adequately retained using the chromatographic conditions were selected. Experiments were conducted using a variety of cell potentials and system configurations (e.g., BDD in series with ESA 6210 cells and/or in series with MS 150; an EC-Array 140 in series with an EC-Array 160; or charged aerosol detection (CAD) as shown in FIG. 1B). FIG. 3A include two panels for comparison of representative chromatograms obtained with a BDD cell, and an ESA Model 6210 cell. The following conditions were used for the results shown in FIG. 3A: a 10 μL injection of a 2 μg/mL mixture (20 ng each) of adenine, adenosine, 7-ethoxycoumarin and tamoxifen with the cell at 1500 mV vs. Pd. Each run consisted of a 15 minute gradient from 1-80% aqueous acetonitrile with constant supporting electrolyte: 50 mM formic acid, 10 mM ammonium formate. The column was a Shiseido MG 4.6×75 mm, 3 μm. There was a 10-fold y-scale amplification of upper graph in FIG. 3A as compared to the y-scale of the lower graph in FIG. 3A. The results were consistent with using BDD to increase the scope of analytes capable of being oxidized at EC cells. Specifically, each component in a mixture of adenine (A), adenosine (AR), 7-ethoxycoumarin (7-EC) and tamoxifen (TAM) was detected using BDD with a signal-to-noise ratio well above 10. By contrast, no signal was observed for AR and 7-EC when using the 6210 cell. Furthermore, the baseline obtained from the BDD cell exhibited much less drift, relative to analyte response, than that of the 6210 cell. Within-run response variability for BDD cells, determined from replicate (n=5) analysis of A, AR, 7-EC and TAM, was less than 4% RSD. Response was linear for all four standards (R² greater than 0.99) within the range of 1 ng to 200 ng on column with a lower LOD estimated to be 1 ng. The response characteristics of BDD cells, for 7-EC in particular, were of interest both from the standpoint of detection and EC-based metabolic mimicry (see below) and suggest that BDD may effect reactions through alternative (e.g., H-abstraction) mechanisms. The devices and methods disclosed herein may provide a general means of extending the scope of EC detection to other functional moieties, and may also provide an alternative route for metabolic mimicry and metabolite synthesis to provide a means to tag electrochemically inactive compounds making them active.

In accordance with certain examples, to study further the possibility that BDD may substantially extend the detection scope, the results obtained from BDD were compared with that of a single ESA 6210 cell for analysis of pooled urine using the described chromatographic conditions. The results show that 45 peaks were evident from a BDD channel vs. a maximum of 28 peaks from any single 6210 channel. The results were consistent with the use of BDD to extend the scope of EC detection.

In accordance with certain examples, LC-EC with carbon-based working electrodes is widely used for routine analysis of aminothiols, disulfides and thioethers, in biological samples. A common limitation of these techniques, however, is loss of EC response over time, which is often attributed to fouling of the WE. BDD cells were compared to a coulometric cell with porous carbon WE (ESA Model 5011 A). Excellent sensitivity (peak height) was obtained with the coulometric cell for glutathione (GSH; about 80 nA/ng) with lower sensitivity for glutathione disulfide (GSSG; about 15 nA/ng). Response for GSSG typically decreased by at least 50% in a single run. Two different BDD cells produced a response of 5.5 and 6.9 nA/ng for GSH and 2.0 and 1.6 nA/ng for GSSG. A striking aspect of the BDD cells was their stability. Over a continuous 24-hour run, the response for both cells varied less than 4% for both analytes. Furthermore, for one of these cells the response for GSH increased by 4% while that of GSSG increased by 13% over a 23-day period. The BDD cells were also used to measure thiols in plasma treated by perchloric acid precipitation of protein. In general, more peaks were observed in plasma samples when using BDD than with a coulometric cell. BDD significantly increased the detection scope of EC with better long-term stability and less baseline drift than porous carbon WE, particularly for high potential applications.

It has been shown that an EC/MS system can be used to mimic metabolism in cases where cytochrome P450 (CytP450) catalyzed reactions proceed via a mechanism initiated by a one-electron oxidation, such as N-dealkylation, S-oxidation, P-oxidation, alcohol oxidation and dehydrogenation. However, perfect mimicry is not observed in all cases. For example, the CytP450 catalyzed reactions initiated via direct hydrogen atom abstraction, such as O-dealkylation and hydroxylation of unsubstituted aromatic rings, generally have too high an oxidation potential to be electrochemically oxidized before electrolysis of solvent occurs, and are not mimicked by the EC/MS system.

In accordance with certain examples, one use of the devices disclosed herein is to electrochemically realize analogous products to those observed by the enzyme-catalyzed oxidation of at least one compound for which no EC mimicry has been observed. O-dealkylation of 7-EC and hydroxylation of phenylalanine (Phe; FIG. 3B) were considered. In FIG. 3B, oxidative metabolism of I yields II (mediated in vivo by phenylalanine hydroxylase). Reactive radical initiated hydroxylation and probable follow-up EC reactions are shown in FIG. 3B. Direct electrooxidation of compound I to yield compound II is highly improbable at the potential applied (+2.2 V). Note that the ortho- and, to a lesser degree, meta-hydroxylation products of I are possible. For simplicity only follow up reactions of p-Tyr are shown. Some of these mechanisms use high initiation overpotentials to proceed electrochemically. Traditionally, electrolysis of analytes with redox potentials over or near +1.2 V in aqueous media is extremely difficult. To achieve the goal of realizing O-dealkylation or aromatic hydroxylation, factors such as electrode material, solvent and electrolyte system, temperature, EC cell geometry, and hydrodynamic conditions were considered and optimized. The following factors were addressed: (1) use of an electrode material that allows an extended useable potential range, (2) use of an electrode material from which hydroxyl radical formation (OH.) is facile, or (3) modify an electrode surface with a catalytic pendent, such as the enzyme recognition region of CytP450. Two tested methods used BDD electrodes and were able to oxidize 7-EC and mimic aromatic ring hydroxylation of Phe. In the case of 7-EC, the primary enzymatic product is umbelliferone; however, a distribution of products was observed when 7-EC was electrolyzed at BDD. Although not all products have yet been identified, most products likely evolve through a combination of OH. insertions and direct EC oxidation.

In accordance with certain examples, the systems described herein provide increased versatility and performance of combined EC/MS platforms in the realm of bioinformatics. The use of a BDD electrode significantly increases the number of potentially important biochemicals measured and/or improves the response characteristics, as evidenced by standards (e.g., adenine, adenosine, B12 [data not shown]) and the appearance of new peaks in plasma samples used for a thiol/disulfide study. The ability of this novel electrode material to elicit a response for these biologically important compounds that, up until now, were thought to be electrochemically unreachable, or yield aberrant responses (viz., tremendous variability, ill defined current response, ‘smearing’ of signal across several EC-Array channels), allows for more complete analysis of biochemicals and integration of these EC data into growing metabolomic databases. The ubiquity and relevance of these compounds is enormous. Adenine, whose roles number far too many to go into detail here is: one of the purine bases found in both DNA and RNA; it is a structural part of many cofactors (e.g., NAD+; NADP+; Coenzyme A; S-adenosylmethionine); it is part of the structure of the cell's metabolic energy carrier (ATP); an intracellular secondary messenger (cAMP); a neuromodulator (adenosine) in the central nervous system; and its catabolism gives rise to antioxidants (e.g., uric acid). Vitamin B12 (cobalamin) is the prosthetic group of two classes of enzymes: mutases (e.g., methylmalonyl-CoA mutase) and methyltransferases (e.g., formation of methionine by methylation of homocysteine). Thiols (e.g., GSH), disulfides (e.g., GSSG) and thioethers (e.g., S-adenosylmethionine) are essential biomolecules, playing critical roles in intermediary metabolism. The physiological importance of GSH can be understood by briefly recounting its roles: it functions as an antioxidant and cofactor (e.g., breaking down hydrogen peroxide and lipid peroxides); is used to regenerate other antioxidants (ascorbic acid); is involved with detoxification of xenobiotics; plays a role in amino acid transport across membranes; and is involved with signal transduction and gene transcription. The GSH/GSSG ratio is normally kept high so that cells experience a reducing environment. This is important as decreases in this ratio are associated with disease and drug-toxicity. HPLC-ECD is one of the few techniques that allow sensitive and direct detection of both GSH and GSSG. Unfortunately, this approach is unreliable at traditional carbon and noble metal electrodes due to electrode fouling, which causes instability and loss of sensitivity. The BDD electrode may be used to reliably measure both GSH and GSSG, and with sufficient sensitivity for routine tissue measurement.

In accordance with certain examples, by employing BDD electrodes, the number of CytP450-based reaction mechanisms emulated by EC may be extended to include those proceeding through hydrogen atom abstraction at aromatic centers (e.g., hydroxylation of phenylalanine to tyrosine) and have shown that oxidation of 7-EC is possible; however, whether the oxidation proceeds through O-dealkylation (to produce umbelliferone)—as occurs in the enzyme catalyzed oxidation—has not been unequivocally established. These findings are important as the metabolism of many xenobiotics (e.g., the dopamine agonist N-0923) and some endogenous metabolites (e.g., tyramine) are initiated by hydrogen atom abstraction.

In accordance with certain examples, the exact mechanism at the BDD remains unknown but likely involves the formation of hydroxyl free radicals (an “EC Fenton” reaction). This mechanism may also be used to “tag” electrochemically inert aromatic species with hydroxy groups, thereby rendering them electrochemically active and extending the suite of chemicals that can be determined by the CoulArray®.

In accordance with certain examples, a thin-layer EC cell may be used in the devices and methods disclosed herein. The demonstrated ability to both detect analytes that are not normally detected by electrochemistry and realize EC synthetic routes to metabolic products with BDD electrodes have led to the development of a thin-layer EC cell using a BDD electrode. This platform can service the metabolomics community in extending the scope of compounds detected; the thin-layer design may be used, for example, with flow rates of tens of μL/min. In addition, a porous BDD electrode may be designed to enhance mass transport properties to the electrode; the unique attributes of a BDD electrode (i.e., low background, anti-fouling surface, extended potential window, and the ability to generate hydroxyl radicals in-situ) makes it particularly useful in the devices and methods disclosed herein. The extremely large electrochemically active surface area provided by porous electrodes yield excellent conversion efficiencies. For detectors, this translates into increased sensitivity and LOD; for reactors, this means that these cells can turn-over a much larger amount of material at higher flow rates than other EC cell designs.

In accordance with certain examples, the devices and methods disclosed herein may be used to identify unknown peaks in a biological sample. Assigning structural identity to unknown peaks found in biological samples is a significant challenge. The EC cells described herein may be applied toward synthesis of biological metabolites of interest. The exact structure of the metabolites may be identified using, for example, NMR. Specific metabolites of interest include putative biomarkers associated with ALS and other forms of motor neuron disease as described by others.

In accordance with certain examples, the devices and methods disclosed herein may be used to identify one or more biomarkers. Examples of biomarkers are described, for example, in Gamache et al. “Metabolomic applications of electrochemistry/mass spectrometry” J. Am. Soc. Mass. Spectrom. 2004, 15, 1717-1726 and in Meyer et al. “Using LC with Parallel Electrochemical Array-MS (LC/ECArray-MS) to Discover Metabolic Biomarkers in the Zucker Diabetic Fatty Rat Model”, San Antonio, Tex. 2005. Archived samples may be used to assess urinary metabolic changes in male Sprague-Dawley rats associated with liver and kidney toxin exposure. A series of methods each with increasing speed of analysis (e.g., 15, 10, 5, 2 and 1 minute analysis time) may be used. Data obtained from these fast-LC methods may be used to assess the developed technology for its ability to achieve substantially higher throughput while also providing improvements in biomarker elucidation based on the number of metabolites, range of chemical classes and qualitative information obtained with sufficient analytical figures of merit. These analyses may be particularly useful in distinguishing xenobiotic and endogenous metabolites; revealing additional potential biomarker peaks from chemometric analyses; and achieving structural confirmation of additional peaks.

Certain specific examples are described in more detail below to illustrate further the novel technology disclosed herein.

### EXAMPLE 1

A boron doped diamond electrode was used to detect eleven (11) compounds including aminothiols, disulfides and thioethers, after their separation by liquid chromatography. BDD electrodes were manufactured according to the protocol described by Christophe Provent, Werner Haenni, Eduardo Santoli and Philippe Rychen in “Boron-doped diamond electrodes and microelectrode-arrays for the measurement of sulfate and peroxodisulfate” Electrochimica Acta, 2004, 49(22-23), 3737-3744. In brief, boron-doped diamond films were synthesized by a hot filament chemical vapor deposition technique (HFCVD). The temperature of the filament ranged from 2440 to 2560° C. and that of the substrate (p-doped monocrystallline silicon) was kept at 830° C. The reactive gas was methane in an excess of hydrogen gas (1% CH₄ in H₂) at 100 mbar pressure. The doping gas was trimethylboron with a concentration of 1 ppm. The gas mixture was supplied to the reaction chamber to give a growth rate up to 0.24 n/h for the diamond layer. The diamond films had a thickness of about 1000-1500 nm and were deposited on conductive p-doped monocrystalline silicon having a doping level of about 2500 ppm.

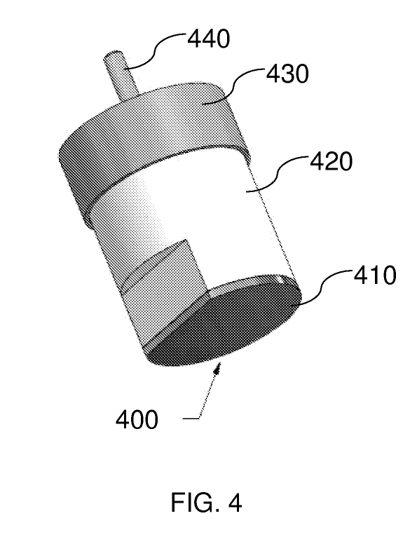

One embodiment of a BDD prepared electrode ready for use in a flowing system is depicted in FIG. 4. Referring to FIG. 4, the electrode 400 includes a BDD electrode disk 410 coupled to an electrode connector holder 420. The electrode connector holder 420 is coupled to an electrode connector cap 430. An electrode connector pin 440 is coupled to the BDD electrode disk 410 to provide a voltage to the (and measure current from) BDD electrode disk 410 from a potentiostat of the detector.

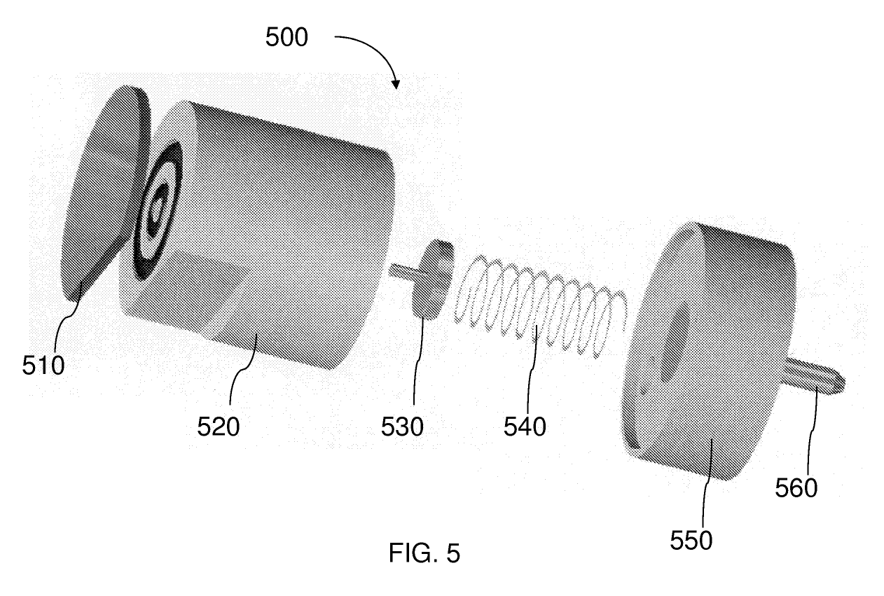

The BDD electrode 400 was used in a contact pin assembly as shown in FIG. 5. The contact pin assembly 500 included a BDD electrode disk 510 coupled to an electrode connector holder 520. An electrode contact pin 530 was in contact with a spring 540 and an electrode connector pin 560. Electrode contact pin 530 was also coupled to the BDD electrode disk 510 to provide electrical coupling between the electrode contact pin 560 and the BDD electrode disk 510. The spring 540 provides an electrical connection between the electrode contact pin 530 and the electrode connector pin 560. The connector cap 550 is coupled to the electrode connector holder 520 so as to compress the spring 540, forcing it to make contact between the two pins 530 and 560.

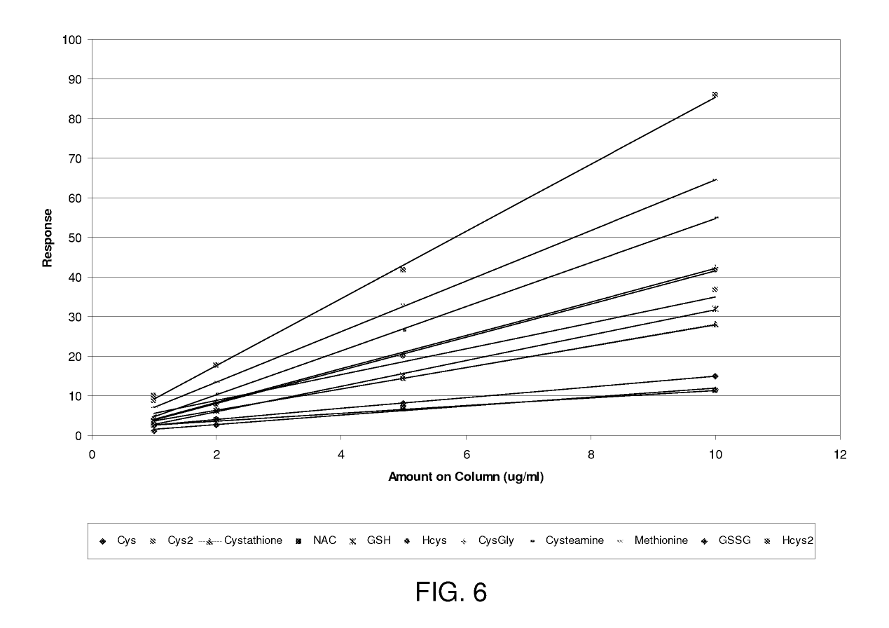

The response of eleven aminothiols, disulfides and thioethers, was evaluated using the BDD electrode. Standard curves for each of the eleven aminothiols, disulfides and thioethers, were constructed using the following method: a mixture of the aminothiols, disulfide and thioethers were separated using a C18 column, and a mobile phase that included an aqueous buffer (25 mM sodium phosphate), ion-pairing agent (1.4 mM octane sulfonic acid) and organic solvent modifier (6% (v/v) acetonitrile), the pH of the mobile phase was brought to 2.65 with phosphoric acid. Analytes were measured on the BDD electrode at +1400 mV versus Pd reference. The HPLC system consisted of a pump, injector, column, electrochemical detector (Coulochem® or CoulArray®) and data station. The eleven aminothiol, disulfide and thioether standards were: cysteine (Cys), cystine (Cys2), cystathione, N-acetylcysteine (NAC), glutathione (GSH), homocysteine (Hcys), cysteinylglycine (CysGly), cysteamine, methionine, glutathione disulfide (GSSG), homocystine (HCys2). The response for each aminothiol generally increased linearly with increasing concentration, as shown in FIG. 6.

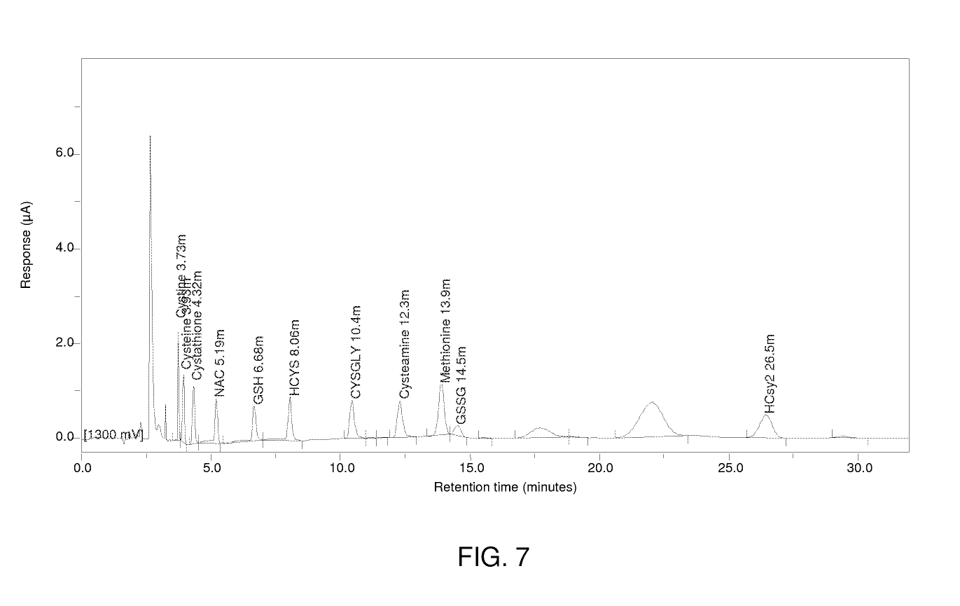

The eleven aminothiols, disulfides and thioethers, (2 ppm of each) were combined in a sample and were separated using the HPLC instrument, C18 column, mobile phase and applied potential described immediately above and using the following parameters: flow rate was 0.75 mL/min; temp was 35° C.; run time was about 30 min. A BDD electrode was used and controlled by a commercially available 16-channel potentiostat (CoulArray®) and were held at 1400 mV vs. a Pd reference electrode. The electrodes demonstrated excellent stability over time and multiple runs. The response was stable for 65 hours for standards with 1.5% RSD for GSH and 6.5% RSD for GSSG. FIG. 7 is a chromatogram showing separation of the eleven aminothiol standards. Baseline separation was possible for each of the eleven aminothiol standards.

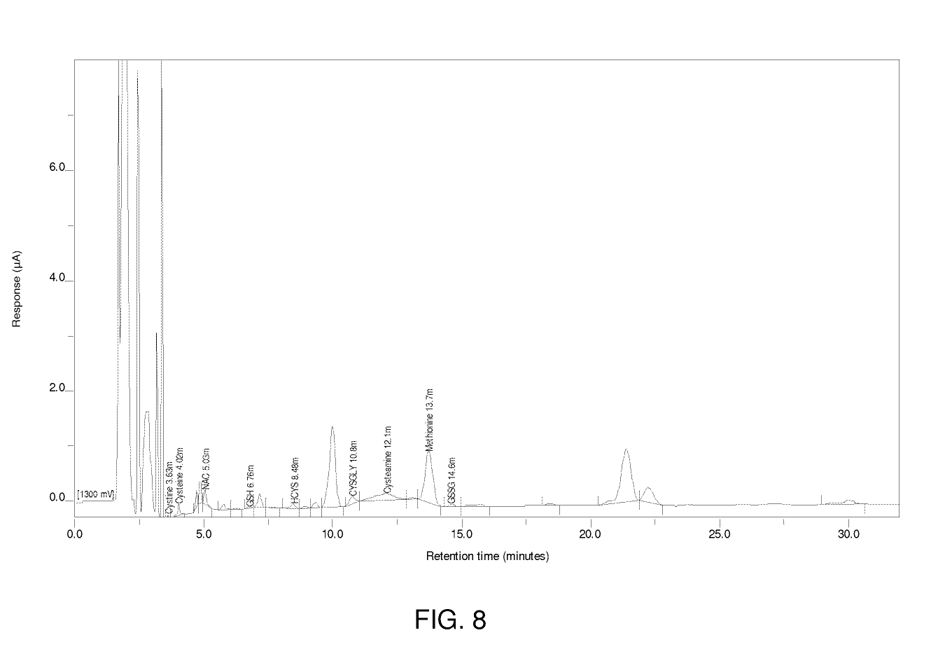

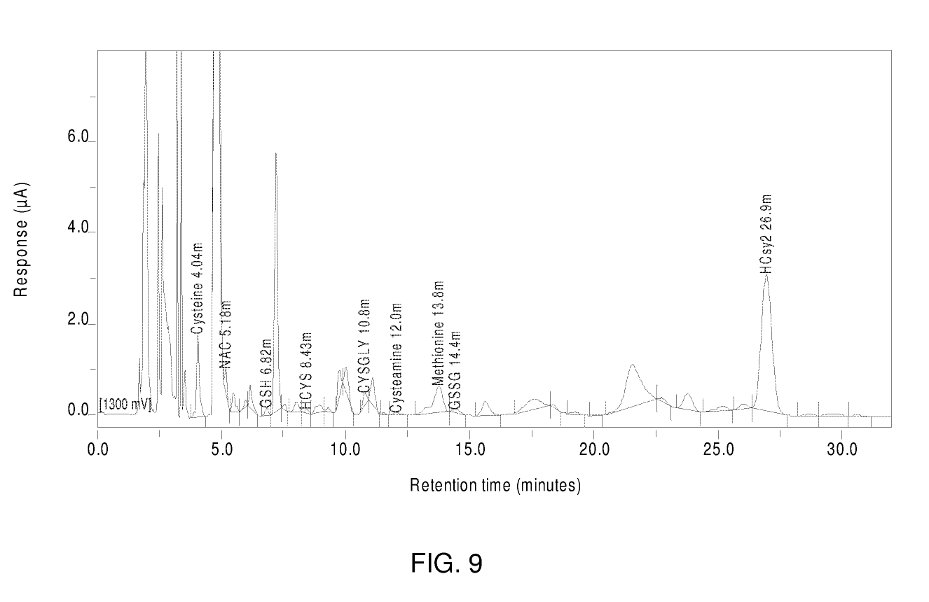

A human plasma control sample was obtained and separated using the HPLC system and conditions described above in this example. FIG. 8 is a chromatogram showing the presence of the aminothiol, disulfide and thioether species in this human plasma control sample. A second plasma sample from a uremic human subject was obtained and separated using the HPLC system and conditions described above in this example. FIG. 9 is a chromatogram showing the presence of the aminothiol, disulfide and thioether species in this sample.

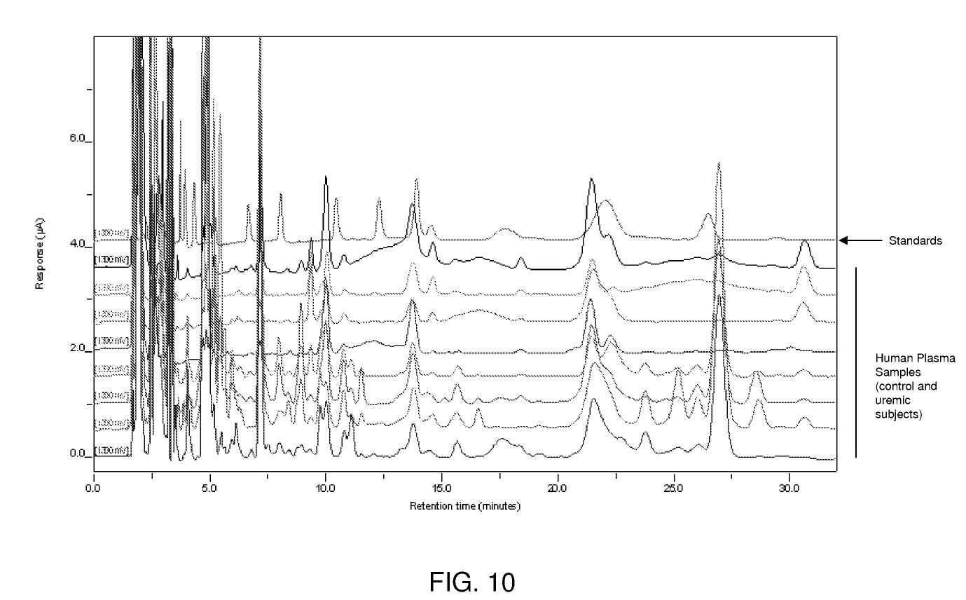

FIG. 10 is an overlay of a standard chromatogram, and various chromatograms from a mixture of non-uremic and uremic subject plasma samples. These chromatograms show that the use of a BDD electrode to activate and detect aminothiol compounds in a sample is highly reproducible and consistent as the species present in the non-uremic and uremic samples have comparable retention times to those of the standards.

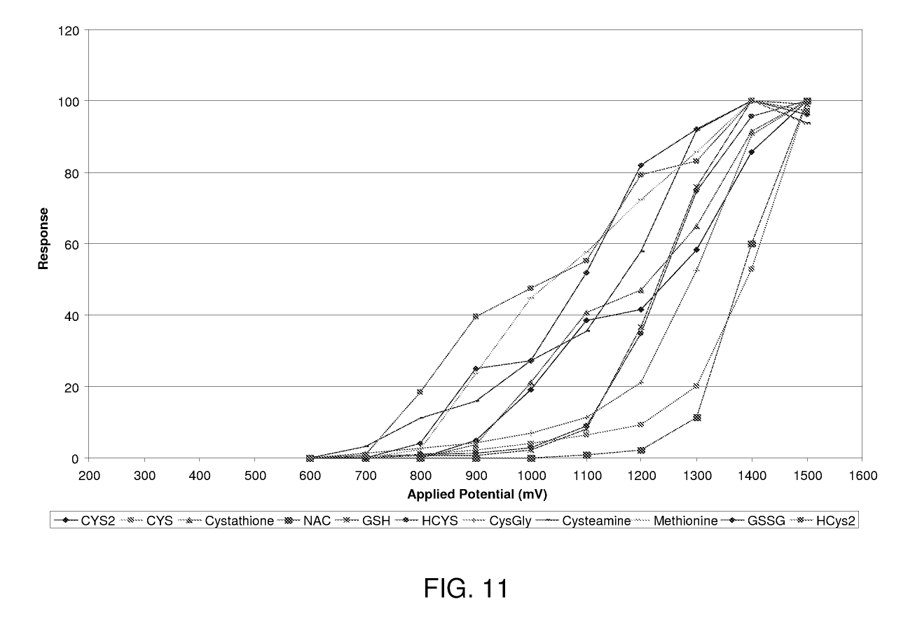

A hydrodynamic voltammetric analysis was performed on each of the eleven aminothiol, disulfide and thioether standards, and the results are shown in FIG. 11. A constant amount of the analytes (10 μg/mL mixture) was analyzed on the HPLC-ECD system described in this example. The potential applied to the BDD electrode started at +1500 mV, and was decreased by 100 mV with each subsequent injection. The signal (current) produced for each analyte was plotted as a function of applied potential. A BDD electrode was used and controlled by a commercially available 16-channel potentiostat (CoulArray®) and was held at 1400 mV vs. a Pd reference electrode. The electrodes demonstrated excellent stability over time and multiple runs. The response was stable for 65 hours for standards with 1.5% RSD for GSH and 6.5% RSD for GSSG.

When introducing elements of the examples disclosed herein, the articles “a,” “an,” “the” and “said” are intended to mean that there are one or more of the elements. The terms “comprising,” “including” and “having” are intended to be open ended and mean that there may be additional elements other than the listed elements. It will be recognized by the person of ordinary skill in the art, given the benefit of this disclosure, that various components of the examples can be interchanged or substituted with various components in other examples. Should the meaning of the terms of the priority application incorporated herein by reference conflict with the meaning of the terms used in this disclosure, the meaning of the terms in this disclosure are intended to be controlling.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

What is claimed is:

1. A device comprising an electrode constructed and arranged to generate a reactive species to activate an electrochemically inactive analyte.

2. The electrode of claim 1, in which the electrode is a boron doped diamond electrode.

3. The device of claim 1, in which the device further comprises a detector configured to detect the activated analyte.

4. The device of claim 3, in which the detector is selected from the group consisting of a mass spectrometer, a charged aerosol detector, and an electrochemical detector.

5. The device of claim 3, in which the device further comprises a second detector configured to detect the activated analyte.

6. The device of claim 5, in which the second detector is selected from the group consisting of a mass spectrometer, a charged aerosol detector, and an electrochemical detector.

7. The device of claim 3, in which the electrode is a boron doped diamond electrode and the detector is selected from the group consisting of a mass spectrometer, a charged aerosol detector, and an electrochemical detector

8. The device of claim 1, in which the electrode is further configured to detect the activated analyte.

9. A system for detecting an electrochemically inactivate analyte, the system comprising:
an injector;
an electrochemical cell fluidically coupled to the injector, the electrochemical cell comprising an electrode constructed and arranged to generate a reactive species to activate an electrochemically inactive analyte; and
a detector configured to receive and detect activated analyte from the electrochemical cell.

10. The system of claim 9, in which the electrode is a boron doped diamond electrode.

11. The system of claim 9, in which the electrode is further configured to detect the activated analyte.

12. The system of claim 9, in which the detector is selected from the group consisting of a mass spectrometer, a charged aerosol detector, and an electrochemical detector.

13. The system of claim 9, further comprising a chromatography column between the injector and the electrochemical cell.

14. The system of claim 9, further comprising a second detector fluidically coupled to the electrochemical cell.

15. A method of detecting an electrochemically inactive analyte using an electrochemical cell, the method comprising:
generating a reactive species using an electrode to activate an electrochemically inactive analyte; and
detecting the activated analyte.

16. The method of claim 15, in which the activating step comprises the use of a boron doped diamond electrode.

17. The method of claim 16, in which the detecting step further comprises electrochemically detecting the activated analyte.

18. The method of claim 16, further comprising selecting the electrochemically inactive analyte to be a biological molecule.

19. The method of claim 18, in which the biological molecules is an amino acid, an antioxidant, a flavonoid, a monoamine, a thiol, a vitamin a carbohydrate, a peptide, and a fatty acid.

20. The method of claim 15, further comprising generating as the reactive species one or more of a hydroxyl free radical, a chlorine radical, a bromine radical, and a nitrogen dioxide radical.

21. The method of claim 15, further comprising providing a mobile phase to the electrode to generate the reactive species.

22. The method of claim 15, further comprising configuring the electrode to detect the activated analyte.

23. An electrode constructed and arranged to generate a reactive species to activate an electrochemically inactive analyte for detection in an electrochemical detector.

24. The electrode of claim 23, in which the electrode is a boron doped diamond electrode.
